(19) United States
(12) Patent Application Publication
(10) Pub. No.: US 2012/0199435 A1
(43) Pub. Date: Aug. 9, 2012

(54) CLUTCH COVER ASSEMBLY

(75) Inventor: Norihisa Uenohara, Ibaraki-shi (JP)

(73) Assignee: EXEDY CORPORATION, Neyagawa-shi, Osaka (JP)

(21) Appl. No.: 13/501,928

(22) PCT Filed: Sep. 3, 2010
(86) PCT No.: PCT/JP2010/065109

§ 371 Date: Apr. 13, 2012

(30) Foreign Application Priority Data
Oct. 15, 2009 (JP) 2009-237878

(51) Int. Cl. F16D 13/40

(52) U.S. Cl. 192/66.31

(57) ABSTRACT

It is an object of the present invention to inhibit degradation in stiffness of a clutch cover in a type of a clutch cover assembly supporting a diaphragm spring by tabs formed using a part of the clutch cover, and thereby, to prevent unsmooth decoupling of a clutch. The clutch cover assembly includes a clutch cover, a pressure plate and a diaphragm spring. The clutch cover is allowed to be fixed to a flywheel and includes an annularly continued inner peripheral edge. The clutch cover includes a circular opening in its center part and plural tabs between its inner and outer peripheries. Each tab is bent towards the flywheel and further towards the clutch cover outer periphery. The pressure plate holds a friction plate with the flywheel for interposing the friction plate therebetween. The diaphragm spring is supported by the clutch cover tabs.

### CROSS-REFERENCE TO RELATED APPLICATIONS

This U.S. national phase application claims priority to Japanese Patent Application No. 2009-237878 filed on Oct. 15, 2010. The entire disclosure of Japanese Patent Application No. 2009-237878 is hereby incorporated herein by reference.

### TECHNICAL FIELD

The present invention relates to a clutch cover assembly, particularly to a clutch cover assembly configured to apply or release pressure of a friction member of a clutch disc assembly onto a flywheel of an engine.

### BACKGROUND ART

The clutch cover assemblies are normally attached to a flywheel of an engine for transmitting driving force of the engine to a transmission. Such clutch cover assemblies mainly include a clutch cover, a pressure plate and a diaphragm spring. The clutch cover is fixed to the flywheel. The pressure plate, together with the flywheel, interposes and holds a friction member of a clutch disc assembly therebetween. The diaphragm spring presses the pressure plate towards the flywheel. The diaphragm spring includes an annular elastic portion and a plurality of lever portions extended radially inwards from the inner peripheral edge of the annular elastic portion. In addition to the function of pressing the pressure plate, the diaphragm spring has a lever function of releasing pressure onto the pressure plate. Further, the diaphragm spring is supported by the clutch cover through a plurality of tabs formed by partially bending the inner periphery of the clutch cover (see Patent Literature 1).

In the aforementioned clutch cover assembly, pressure of the diaphragm spring onto the pressure plate is released when the tips of the lever portions of the diaphragm spring are pressed by a release mechanism. Accordingly, the clutch is turned off (i.e., power transmission is blocked).

### CITATION LIST

### Patent Literature

PTL 1: Japan Laid-open Patent Application Publication No. JP-A-2007-198507

### SUMMARY

### Technical Problems

When the clutch is turned off as described above, the tips of the lever portions of the diaphragm spring is pressed by the release mechanism. The clutch cover supporting the diaphragm spring is herein deformed. In this case, the clutch is not smoothly decoupled when the clutch cover is largely deflected. Specifically, when a part of the clutch cover, supporting the diaphragm spring, is moved due to deflection of the clutch cover, pressure of the diaphragm spring onto the pressure plate is not reliably released even if the release mechanism is moved by the release amount set for clutch-off. Consequently, the clutch is not reliably turned off.

Therefore, the clutch cover preferably has higher stiffness for smoothly decoupling the clutch. The clutch cover is herein formed by pressing a sheet metal. Therefore, it can be assumed to form the clutch cover with large thickness for enhancing the stiffness of the clutch cover. However, this is not preferable because the weight of the clutch cover is increased in proportion to the thickness of the clutch cover.

Further, in a type of the clutch cover supporting the diaphragm spring through tabs formed by bending a part of the inner periphery of the clutch cover as described in Patent Literature 1, the inner periphery of the clutch cover is largely cut out for forming the tabs. Therefore, chances are that the clutch cover has low stiffness and decoupling of the clutch becomes further unsmooth.

It is an advantage of the present invention to inhibit degradation in stiffness of a clutch cover in a type of a clutch cover assembly supporting a diaphragm spring through tabs formed using a part of the clutch cover, and thereby to prevent unsmooth decoupling of a clutch.

### Solution to Problems

A clutch cover assembly according to a first aspect of the present invention is configured to apply or release pressure of a friction member of a clutch disc assembly onto a flywheel of an engine. The clutch cover assembly includes a clutch cover, a pressure plate and a diaphragm spring. The clutch cover is allowed to be fixed to the flywheel. The clutch cover includes a circular opening in a center part thereof. The clutch cover further includes an inner peripheral edge annularly continued and a plurality of tabs between an inner periphery thereof and an outer periphery thereof. The tabs are bent towards the flywheel and further towards the outer periphery of the clutch cover. The pressure plate is coupled to the clutch cover in a relatively non-rotatable state. The pressure plate holds the friction member together with the flywheel for interposing the friction member therebetween. The diaphragm spring is supported by the tabs of the clutch cover. The diaphragm spring is configured to urge the pressure plate towards the flywheel.

According to the clutch cover assembly of the first aspect of the present invention, pressure of the friction member onto the flywheel is released by releasing pressure force of the diaphragm spring onto the pressure plate through a release operation. The clutch is thereby turned off. In such a release operation, release force acts on the diaphragm spring and also acts on the clutch cover supporting the diaphragm spring. Further, the inner peripheral edge of the clutch cover is herein annularly continued.

Therefore, the clutch cover of the present invention has stiffness higher than that of a well-known clutch cover. In other words, the clutch cover is not easily deformed and its deflection amount is small even when the release force acts thereon. Accordingly, performance of decoupling the clutch is enhanced.

A clutch cover assembly according to a second aspect of the present invention relates to the clutch cover assembly according to the first aspect of the present invention. In the clutch cover assembly, the clutch cover includes a brim portion on the inner peripheral edge thereof. The brim portion is axially protruded away from the flywheel in an annularly continued shape.

According to the clutch cover assembly of the second aspect of the present invention, stiffness of the clutch cover is further enhanced due to the brim portion formed on the inner peripheral edge of the clutch cover. This further reduces the deflection amount of the clutch cover in a release operation. Accordingly, the clutch decoupling performance can be further enhanced.

A clutch cover assembly according to a third aspect of the present invention relates to the clutch cover assembly according to the first aspect of the present invention. The clutch cover assembly further includes a pair of wire rings supporting the diaphragm ring together with the tabs.

A clutch cover assembly according to a fourth aspect of the present invention relates to the clutch cover assembly according to the first aspect of the present invention. In the clutch cover assembly, the clutch cover includes a plurality of punched holes for forming the tabs, every adjacent two of the punched holes are formed independently from each other. The clutch cover includes bridge portions for coupling the inner periphery thereof and the outer periphery thereof. Each bridge portion is disposed between every two adjacent two of the punched holes.

According to the clutch cover assembly of the fourth aspect of the present invention, each of the bridge portions is disposed between every adjacent two of the punched holes for forming the tabs. Stiffness of the clutch cover is thereby further enhanced. Accordingly, the clutch decoupling performance can be further enhanced.

A clutch cover assembly according to a fifth aspect of the present invention relates to the clutch cover assembly according to the first aspect of the present invention. The clutch cover assembly further includes at least an elastic member and a restriction mechanism. The elastic member (or members) is supported by the clutch cover. The elastic member (or members) is configured to produce load acting against pressure force of the diaphragm spring. The restriction mechanism is configured to restrict movement of the pressure plate towards the flywheel within a predetermined range. Further, the clutch cover includes a fixed portion and at least an accommodation portion. The fixed portion is fixed to the flywheel. The accommodation portion (or portions) accommodates the elastic member (or members). The accommodation portion (or portions) is disposed radially inwards of the fixed portion. The accommodation portion (or portions) is dented towards the pressure plate. The restriction mechanism is configured to be realized when the diaphragm spring makes contact with the clutch cover. The elastic member (or members) is disposed on an axially opposite side of the pressure plate through the diaphragm spring.

According to the clutch cover assembly of the fifth aspect of the present invention, the restriction mechanism is configured to restrict movement of the pressure plate, for instance, when the wear amount of the friction member reaches the maximally allowed wear amount. Therefore, the urging action of the diaphragm spring and the displacement amount of the pressure plate are restricted to a predetermined range even when the pressure plate is urged by the diaphragm spring without attachment of the flywheel and the friction member, for instance, in manufacturing or shipping the clutch cover assembly. Consequently, deformation of the elastic member, thereby producing load acting against the urging force of the diaphragm spring, is restricted to a predetermined range. Thus, the clutch cover assembly can prevent plastic deformation of the elastic member due to excessive deflection when manufactured or shipped.

It should be herein noted that the maximally allowed wear amount of the friction member refers to the maximum wear amount in a wear amount range that the friction member can exert a desired torque transmission characteristic.

A clutch cover assembly according to a sixth aspect of the present invention relates to the clutch cover assembly according to the fifth aspect of the present invention. In the clutch cover assembly, the restriction mechanism is configured to be realized when the diaphragm spring makes contact with the at least an accommodation portion.

A clutch cover assembly according to a seventh aspect of the present invention relates to the clutch cover assembly according to the fifth aspect of the present invention. In the clutch cover assembly, the restriction mechanism is configured to be realized when the diaphragm spring makes contact with the inner peripheral edge of the clutch cover.

A clutch cover assembly according to an eighth aspect of the present invention relates to the clutch cover assembly according to the fifth aspect of the present invention. In the clutch assembly, an axial position of the pressure plate restricted by the restriction mechanism corresponds to a pressing position of the pressure plate where a wear amount of the friction member reaches a maximally allowed wear amount.

### Advantageous Effects of the Invention

According to the present invention, deformation of a clutch cover is inhibited and the deflection amount of the clutch cover is reduced. Therefore, a clutch decoupling performance can be enhanced.

### BRIEF DESCRIPTION OF THE DRAWINGS

FIG. 1 is a schematic vertical cross-sectional view of a clutch cover assembly according to an exemplary embodiment of the present invention.

FIG. 2 is a schematic plan view of the clutch cover assembly.

FIG. 3 is a partial enlarged view of FIG. 2.

FIG. 4 is a chart for explaining a pressure load characteristic.

### DETAILED DESCRIPTION OF EXEMPLARY EMBODIMENTS

(Entire Structure)

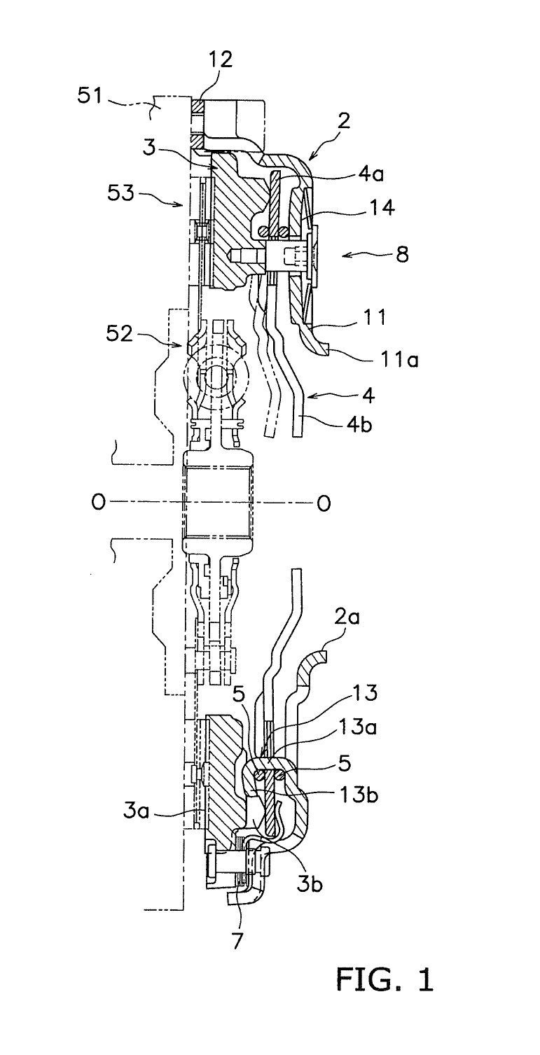

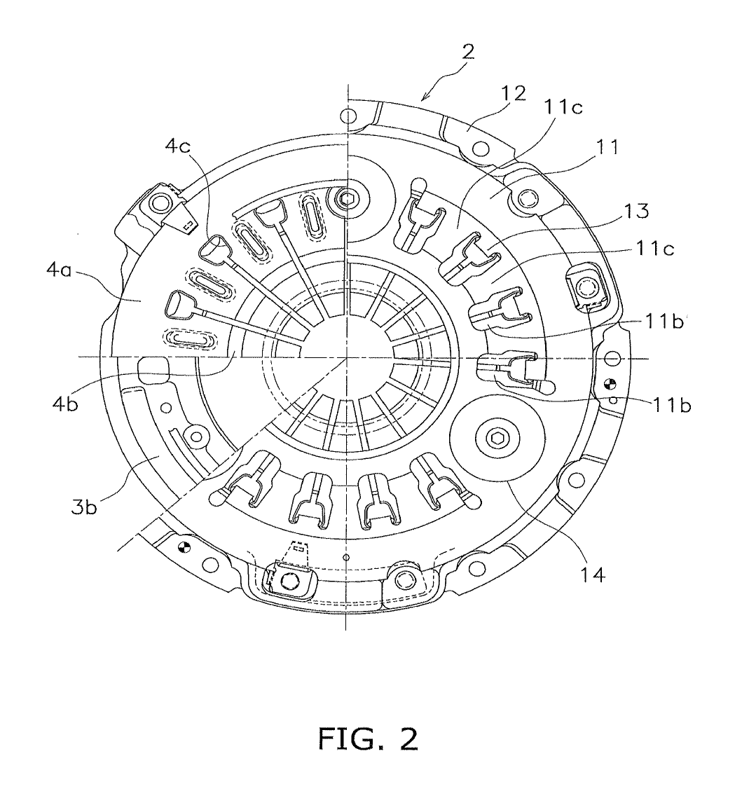

FIG. 1 is a schematic vertical cross-sectional view of a clutch cover assembly 1, whereas FIG. 2 is a schematic plan view of the clutch cover assembly 1. In FIGS. 1 and 2, a line O-O indicates a rotational axis for a flywheel 51 and the clutch cover assembly 1. In FIGS. 1 and 2, the left side is hereinafter referred to as “an axially engine side” , while the right side is referred to as “an axially transmission side”.

The clutch cover assembly 1 is a device for coupling (turning on) a clutch by pressing a friction member 53 of a clutch disc assembly 52 onto the flywheel 51 of the engine and for decoupling (turning off) the clutch by releasing the pressure of the friction member 53 onto the flywheel 51. It should be noted that the friction member 53 includes at least a friction facing and at least a cushioning plate. The friction member 53 is axially deflectable within a predetermined range and thus has a cushioning function.

The clutch cover assembly 1 mainly includes a clutch cover 2, a pressure plate 3 and a diaphragm spring 4.

(Clutch Cover)

The clutch cover 2 is a roughly saucer-shaped plate member having a circular opening 2a in the center part thereof. The outer periphery of the clutch cover 2 is fixed to the flywheel 51 by means of, for instance, bolts. The clutch cover 2 includes a plate-shaped portion opposed to the outer periphery of the flywheel 51 at a clearance in the axial direction. More specifically, the clutch cover 2 includes a clutch cover main body 11, an attachment flange portion 12, a plurality of tabs 13 and three accommodation portions 14. The clutch cover main body 11 forms a main part of the clutch cover 2. The attachment flange portion 12 is formed on the outer periphery of the clutch cover main body 11. The plural tabs 13 support the diaphragm spring 4. The accommodation portions 14 are formed on the clutch cover main body 11.

The inner periphery of the clutch cover main body 11 is annularly continued. The inner peripheral edge of the clutch cover main body 11 is axially raised and protruded towards the transmission by means of burring, and is thus formed as an annularly continued brim portion 11a.

The plural tabs 13 are respectively formed by bending respective punched holes 1b formed by partially cutting out a radially intermediate part between the inner periphery and the outer periphery of the clutch cover main body 11. Each tab 13 includes a first support portion 13a and a second support portion 13b. The first support portion 13a is extended axially towards the engine from the clutch cover main body 11. The second support portion 13b is extended radially outwards from the first support portion 13a. It should be noted that the punched holes 11b are independently formed. Therefore, a bridge portion 11c is formed between every pair of adjacent punched holes 11b, while connecting the outer periphery and the inner periphery of the clutch cover main body 11.

Each accommodation portion 14 is formed by circularly embossing a part of the clutch cover main body 11. Each accommodation portion 14 forms a part of a restriction mechanism to be described.

(Pressure Plate)

The pressure plate 3 is an annular member having a pressure face 3a on one side thereof faced to the flywheel 51. The friction member 53 of the clutch disc assembly 52 is disposed between the pressure face 3a and the flywheel 51. The pressure plate 3 includes an annular protruded portion 3b axially protruded from the other side thereof opposite to the pressure face 3a. The pressure plate 3 is coupled to the clutch cover 2 by means of a plurality of strap plates 7 while being axially movable but relatively non-rotatable with respect thereto.

(Diaphragm Spring)

The diaphragm spring 4 is a disc-shaped member disposed between the pressure plate 3 and the clutch cover 2. The diaphragm spring 4 includes an annular elastic portion 4a and a plurality of lever portions 4b extended radially inwards from the inner periphery of the annular elastic portion 4a. The annular elastic portion 4a makes contact with the protruded portion 3b of the pressure plate 3. The inner periphery of the annular elastic portion 4a is supported by the tabs 13 of the clutch cover 2 through a pair of wire rings 5. More specifically, a slit is formed between every pair of adjacent lever portions 4b. Each slit includes a roughly oval hole 4c on the outer periphery thereof. In other words, the holes 4c are formed on the inner peripheral edge of the annular elastic portion 4a (i.e., the base ends (outer peripheral edges) of the lever portions 4b). The first and second support portions 13a and 13b of each tab 13 herein penetrates each hole 4c . Further, one of the paired wire rings 5 is disposed between the clutch cover main body 11 and the diaphragm spring 4, while the other of the paired wire rings 5 is disposed between the diaphragm spring 4 and the second support portion 13b. With the structure, the annular elastic portion 4a of the diaphragm spring 4 can be moved closer to or away from the protruded portion 3b of the pressure plate 3 about the tabs 13 and the wire rings 5 as a fulcrum.

It should be noted that a push-type release device (not illustrated in the figures) is engaged with the tips of the lever portions 4b of the diaphragm spring 4. The release device is formed by components such as a release bearing.

(Low Release Load Characteristic Realizing Mechanism)

The clutch cover assembly 1 of the present exemplary embodiment includes low release load characteristic realizing mechanisms 8. Each low release load characteristic realizing mechanism 8 is configured to flatten a pressure load characteristic for realizing a low release load characteristic even when the friction member 53 is further worn. In the present exemplary embodiment, three low release load characteristic realizing mechanisms 8 are aligned in the circumferential direction of the clutch cover assembly 1. Therefore, the low release load characteristic realizing mechanisms 8 produce well-balanced load in the circumferential direction of the clutch cover assembly 1.

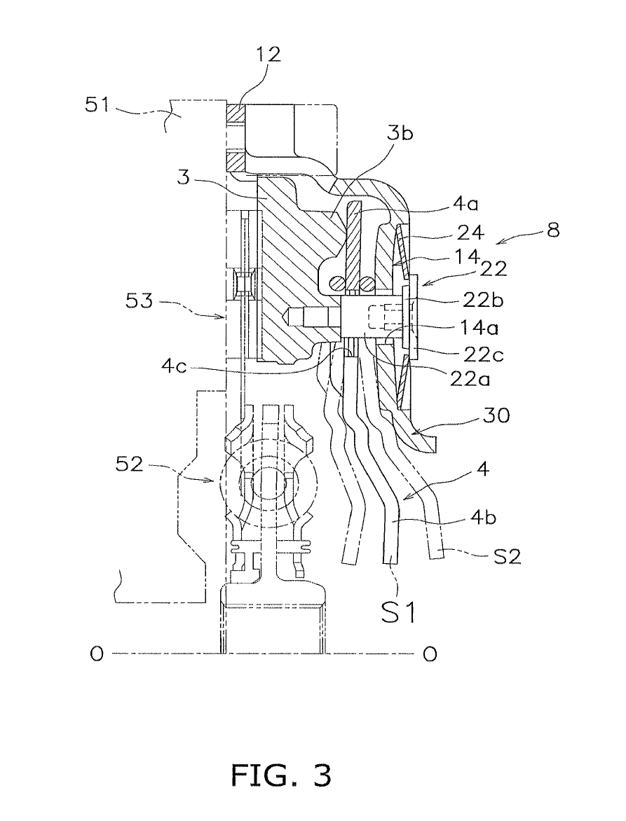

The low release load characteristic realizing mechanisms 8 are disposed in positions corresponding to the accommodation portions 14 of the clutch cover 2. As illustrated in FIG. 3, each low release load characteristic realizing mechanism 8 includes a support bolt 22 (i.e., a support member) and a cone spring 24 (i.e., an elastic member). Each support bolt 22 is axially extended towards the transmission from the inner periphery of the protruded-portion-3b side face of the pressure plate 3. Each support bolt 22 includes a trunk portion 22a, a head portion 22b and a flange portion 22c . The head portion 22b has an outer diameter greater than that of the trunk portion 22a. Further, the flange portion 22c has an outer diameter greater than that of the head portion 22b. The trunk portion 22a of each support bolt 22 passes through each oval hole 4c of the diaphragm spring 4 and is further axially extended therefrom. Each accommodation portion 14 of the clutch cover 2 is axially dented towards the engine in a bowl shape. Each accommodation portion 14 includes a hole 14a arranged correspondingly to each support bolt 22. The trunk portion 22a of each support bolt 22 passes through each hole 14a and is further axially extended therefrom. As a result, the head portion 22b of each support bolt 22 is positioned axially closer to the transmission than each accommodation portion 14 is. Each cone spring 24 is accommodated in an axially transmission side region within each axially dented accommodation portion 14. The outer peripheral edge of each cone spring 24 is supported by the outer peripheral edge of each accommodation portion 14. The inner peripheral edge of each cone spring 24 is supported by the flange portion 22c of each support bolt 22.

In an unworn state of the clutch, the cone springs 24 do not produce any load during coupling of the clutch. When the friction member 53 of the clutch disc assembly 52 is worn, by contrast, the pressure plate 3 and the support bolts 22 are axially moved towards the engine. The cone springs 24 are thereby compressed between the clutch cover 2 and the flange portions 22c of the support bolts 22. Accordingly, the cone springs 24 apply axial load to the both members. The load, applied to members including support bolts 22 by means of the cone springs 24, acts in a direction opposite to that of the pressure load applied to the pressure plate 3 by means of the diaphragm spring 4. Therefore, the load by the cone springs 24 reduces the pressure load by the diaphragm spring 4. As a result, the release load is also inhibited to a lower level.

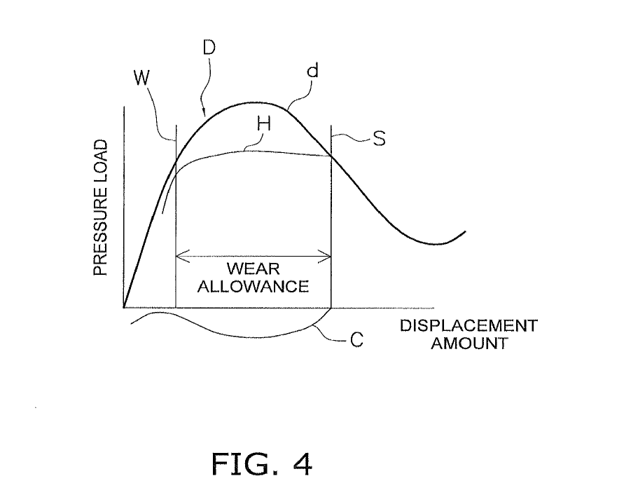

The aforementioned action of the low release load characteristic realizing mechanism will be explained with reference to a pressure load characteristic curve in FIG. 4. FIG. 4 represents a load characteristic D of the diaphragm spring 4 and wear allowance of the friction member 53 in the present exemplary embodiment. As is obvious from FIG. 4, the load characteristic D of the diaphragm spring 4 has a peak portion d. By contrast, a characteristic C of the cone springs 24 of the low release load characteristic realizing mechanism 8 has a peak portion (i.e., a downwardly convex portion) on the opposite side of the peak portion d of the diaphragm spring 4 for cancelling out the peak portion d. Accordingly, a synthetic load flattened portion H is formed. Thus, the cone springs 24 realize the synthetic load flattened portion H with sufficiently large wear allowance. Even if the friction member 53 is worn, tread force of the clutch pedal is hardly changed from that obtained when the friction member 53 is unworn. In other words, operability is enhanced in a release operation.

(Restriction Mechanism)

The clutch cover assembly 1 includes a restriction mechanism 30. The restriction mechanism 30 is configured to restrict movement of the pressure plate 3 towards the flywheel 51 through the diaphragm spring 4. As illustrated in FIG. 3, the restriction mechanism 30 specifically includes the accommodation portions 14 of the clutch cover 2 and the lever portions 4b of the diaphragm spring 4. Specifically, each accommodation portion 14 has a bowl shape axially dented towards the engine as described above. Therefore, the lever portions 4b of the diaphragm spring 4 are allowed to make contact with the axially engine-side lateral surface of each accommodation portion 14 when the diaphragm spring 4 is axially moved towards the transmission.

The relation between the wear amount of the friction member 53 and positions of the pressure plate 3 and the diaphragm spring 4 will be hereinafter explained. In the initial state where the friction member 53 is unworn, the diaphragm spring 4 is set to be in a position S1 depicted with a solid line in FIG. 3 during coupling of the clutch. In the state, a clearance is produced axially between the lever portions 4b and the lateral surface of each accommodation portion 14.

When the wear amount of the friction member 53 reaches the maximally allowed wear amount, by contrast, the pressure plate 3 is axially moved towards the engine and the diaphragm spring 4 is set to be in a position S2 depicted with a dashed two-dotted line. Accordingly, the lever portions 4b of the diaphragm spring 4 make contact with the lateral surface of each accommodation portion 14. The maximally allowed wear amount of the friction member 53 herein means the maximum wear amount in a wear amount range that the friction member 53 can exert a desired torque transmission characteristic and corresponds to the wear allowance ranged from a set line S to a wear line W in FIG. 4.

With the aforementioned structure, the restriction mechanism 30 is configured to restrict the urging action of the diaphragm spring 4 at the position S2 under the condition that the main components of the clutch cover assembly 1 are assembled. In conjunction with this, movement of the pressure plate 3 towards the flywheel 51 is also restricted. The deformation amount of the cone springs 24 of the low release load characteristic realizing mechanism 8 is thereby limited to a predetermined range, even when the pressure plate 3 is urged by the diaphragm spring 4 without attachment of the flywheel 51 and the friction member 53, for instance, in manufacturing or shipping the clutch cover assembly 1. Put the above together, the clutch cover assembly 1 can prevent plastic deformation of the cone springs 24 due to excessive deflection in manufacturing and shipping thereof. Consequently, it is possible to obtain a desired low release load characteristic.

(Clutch Coupling and Releasing Actions)

In the clutch cover assembly 1, the annular elastic portion 4a applies pressure load to the pressure plate 3 under the condition that the release device (not illustrated in the figures) does not apply load to the tips of the lever portions 4b of the diaphragm spring 4. As a result, the friction member 53 of the clutch disc assembly 52 is pressed onto the flywheel 51 and torque is thereby transmitted to the clutch disc assembly 52 (i.e., a clutch-on state).

When the release device (not illustrated in the figures) presses and moves the tips of the lever portions 4b of the diaphragm spring 4 towards the engine, the outer periphery of the annular elastic portion 4a of the diaphragm spring 4 is axially pulled up towards the transmission about the wire rings 5 as a fulcrum. Accordingly, the annular elastic portion 4a releases pressure applied to the pressure plate 3 and the pressure plate 3 is separated from the friction member 53 by means of the strap plates 7. Finally, the friction member 53 is separated from the flywheel 51 (i.e., a clutch-off state).

(Other Exemplary Embodiments)

(a) In the aforementioned exemplary embodiment, movement of the pressure plate 3 towards the flywheel is restricted by causing the lever portions 4b of the diaphragm spring 4 to make contact with the engine-side lateral surface of each accommodation portion 14. However, the structure of the restriction mechanism is not limited to the above. For example, the lever portions 4b can be configured to make contact with the inner peripheral edge of the clutch cover 2.

(b) In the aforementioned exemplary embodiment , the clutch cover assembly including the restriction mechanism 30 has been explained. However, the present invention can be similarly applied to a clutch cover assembly without the restriction mechanism 30.

(c) The aforementioned exemplary embodiment is only an example of the present invention, and a variety of changes can be herein made without departing from the scope of the present invention. For example, the aforementioned exemplary embodiment relates to the push-type clutch cover assembly. However, the present invention can be also applied to a pull-type clutch cover assembly.

### INDUSTRIAL APPLICABILITY

According to the present invention, deformation of a clutch cover can be inhibited and the deflection amount of the clutch cover can be thereby reduced. It is thereby possible to obtain a clutch cover assembly with enhanced performance of decoupling

1. A clutch cover assembly configured to apply or release pressure of a friction member of a clutch disc assembly onto a flywheel of an engine, the clutch cover assembly comprising:
a clutch cover being configured to the flywheel, the clutch cover including a circular opening in a center part thereof, an inner peripheral edge being annularly formed, and a plurality of tabs between an inner periphery thereof and an outer periphery thereof, the tabs including a first portion extending towards the flywheel and a second portion extending towards the outer periphery of the clutch cover;
a pressure plate being coupled to the clutch cover in a relatively non-rotatable state against the clutch cover, the pressure plate holding the friction member together with the flywheel for interposing the friction member therebetween; and
a diaphragm spring being supported by the tabs of the clutch cover, the diaphragm spring being configured to urge the pressure plate towards the flywheel.

2. The clutch cover assembly recited in claim 1, wherein
the clutch cover includes a brim portion on the inner peripheral edge thereof, the brim portion axially protruding away from the flywheel, the brim portion being annularly shaped.

3. The clutch cover assembly recited in claim 1, further comprising
a pair of wire rings supporting the diaphragm ring together with the tabs.

4. The clutch cover assembly recited in claim 1, wherein
the clutch cover includes a plurality of punched holes for forming the tabs,
every adjacent two of the punched holes are formed independently from each other,
the clutch cover include a plurality of bridge portions for coupling the inner periphery thereof and the outer periphery thereof, each of the bridge portions disposed between every two adjacent two of the punched holes.

5. The clutch cover assembly recited in claim 1, further comprising
an elastic member being supported by the clutch cover, the elastic member being configured to produce a load acting against a pressure force of the diaphragm spring; and
a restriction mechanism being configured to restrict movement of the pressure plate towards the flywheel within a predetermined range, wherein
the clutch cover includes a fixed portion to be fixed to the flywheel, and an accommodation portion being configured to accommodate the elastic member,
the accommodation portion is disposed radially inwards of the fixed portion and is dented towards the pressure plate,
the restriction mechanism is configured to restrict the movement when the diaphragm spring makes contact with the clutch cover, and
the elastic member is disposed on an axially opposite side of the pressure plate.

6. The clutch cover assembly recited in claim 5, wherein
the restriction mechanism is configured to restrict the movement when the diaphragm spring makes contact with the accommodation portion.

7. The clutch cover assembly recited in claim 5, wherein
the restriction mechanism is configured to restrict the movement when the diaphragm spring makes contact with the inner peripheral edge of the clutch cover.

8. The clutch cover assembly recited in claim 5, wherein
an axial position of the pressure plate restricted by the restriction mechanism corresponds to a pressing position of the pressure plate where a wear amount of the friction member reaches a maximally allowable wear amount.
